(19) United States
(12) Patent Application Publication
(10) Pub. No.: US 2002/0029149 A1
(43) Pub. Date: Mar. 7, 2002

(54) Food menu providing system

(76) Inventor: Masao Nishina, Tokyo (JP)

Correspondence Address: WELLS ST JOHN ROBERTS GREGORY AND MATKIN, SUITE 1300, 601 W FIRST AVENUE, SPOKANE, WA, 992013828

(21) Appl. No.: 09/898,790

(22) Filed: Jul. 2, 2001

(30) Foreign Application Priority Data
Sep. 1, 2000 (JP) 2000-265259

(51) Int. Cl. G06F 17/60; G06F 17/00

(52) U.S. Cl. 705/1; 700/90

(57) ABSTRACT

For optionally changing food menus at a user side, for reducing leftover food materials, and for promptly providing new food menus, the food menu providing system according to the instant invention provides food menus applicable for a predetermined period; a cooking recipe for each of the food menus; and a food material list having food material data such as quantity of all food materials necessary to the food menus applicable for the predetermined period, to the user through the communication network.

### RELATED APPLICATIONS

This application relates to and claims priority to corresponding Japanese Patent Application No. 2000-265259 filed on Sep. 1, 2000.

### BACKGROUND OF THE INVENTION

1. Field of the Invention

The present invention relates to a food menu providing system for providing a user with a food menu applicable for a predetermined period, and more particularly to a food menu providing system which enables the user to use up food materials by providing a food material list of food materials necessary for the food menu for the predetermined period. Also, the present invention relates to a food menu providing system which enables the provision of other food menus in accordance with user's taste, or by using leftover food material data.

2. Description of the Related Art

Since it is troublesome to think of a food menu for dinner everyday, many homemakers, 60%, do not wish to bother to think of the food menu (this being a result of a questionnaire to about 520 women from 20 to 69 years old reported in Yomiuri news letter on Sep. 22, 1998). Also, when a homemaker goes to a supermarket with the food menu having not been decided, the time is wasted by walking around in the supermarket. Such a situation quite often occurs (according to the above Yomiuri news letter). For overcoming such trouble even to a small extent, cooking recipes written with various meals or cooking methods therefor exist. These cooking recipes are provided by such printed matters as books. Generally, the homemaker decides a food menu for dinner from the cooking recipe books. Then, the homemaker purchases food materials used by the meals in accordance with the cooking recipes. Also, in recent years, there are recording media such as CD-ROMs for providing the cooking recipe, which is made as electronic data, on a personal computer with the development of personal computers. Further, for saving time, there are catering services in which meals for dinner are delivered.

In the case where the food materials are purchased after the meals are decided from the cooking recipe books, some food materials unavoidably remain. This is because the food materials are usually sold in a “pack” at a market such as a supermarket, the homemaker cannot help purchasing the food material with a quantity over that of the food material written on the cooking recipe. For avoiding generating such waste food materials, there are publications such as Japanese Utility Model Application Kokoku Publication Nos. Hei 7-46548 and Hei 7-46549 or there is an application such as Japanese Patent Application No. Hei 11-329393, all are filed by the same inventor as in the present application. These are intended to consume food materials effectively by using a shopping list written with a food menu for one week, names or quantities of food materials therefor, etc.

However, the more the kinds of meals are provided, the more the food menus may become interested in, but in the case where the food menus are provided in the paper base, printing costs become enormous, so that it is difficult to provide the cooking recipe books to satisfy all users. Further, since the cooking recipes recorded on the recording media such as CD-ROMs cannot be updated generally, it is impossible to provide a prompt food menu such as the latest popular food menu, and a food menu using the latest popular food materials. Also, in the catering services, there is a problem in disposing of a wrapping material such as a wrapping box.

Also, since each of the above Japanese Utility Model Application Kokoku Publication Nos. Hei 7-46548 and Hei 7-46549 and Japanese Patent Application No. Hei 11-329393 provides cooking recipes and food material lists on a paper base, these cannot comply with demands from users such as a changing of a food menu, and a providing of a food menu for using leftover food materials which were purchased in excess. That is, these are not interactive systems. Therefore, it is realistically impossible to provide food menus adapting to individual user's needs (avoiding of allergic food, etc.) or user's tastes. It is also impossible to change a part of meals to other meal within the food menus provided for one week. Thus, even if the food materials are purchased in accordance with the shopping list, when other meals are made, the food materials are left over. Therefore, since the user has to follow the provided food menu, the conventional system is inconvenient. Further, occasionally, the number of persons who eat may decrease, or there are persons who eat out. In such a case, not all the food materials are used so that the homemaker is bothered as to how to cook the leftover food materials effectively.

In view of the above circumstances, the present invention relates to a food menu providing system in which it is possible to freely change the food menu at the user side so as to reduce leftover foods, and to further provide a food menu of a new meal as it becomes available.

### SUMMARY OF THE INVENTION

An object of the present invention, therefore, is to overcome the problems existing in the prior art, and to provide a food menu providing system provided on a communication network for providing a user with food menus to be used for a predetermined period, the system being characterized in that: the food menu providing system provides to the user through the communication network the following: food menus applicable for the predetermined period; a cooking recipe for each of the food menus; and a food material list having food material data such as quantity of all food materials necessary to the food menus applicable for the predetermined period.

The food material list may comprise a shopping list for use by the user to purchase at one time the food materials necessary to the food menus applicable for the predetermined period.

The shopping list may be transmitted to a portable terminal unit supporting the e-mail.

The food material list may further be provided to a shop which sells the food materials, and the food materials necessary to the food menus applicable for the predetermined period may be collected in advance at the shop, and the collected food materials are provided to the user.

The food materials listed on the food material list may further be delivered to the user in one lot.

Other food menus may also be provided instead of the provided food menus in accordance with a request of the user based on the food materials necessary to the food menus applicable for the predetermined period.

If a part of the food materials is left, food menus which use the leftover food materials are further provided based on data of the leftover food materials.

The food menu providing system may provide food menus which satisfy conditions designated by the user.

The cooking recipe may include at least any one of still image data, movie image data and voice data.

The predetermined period may be one week, for example.

According to the invention, because the food menu for a predetermined period, for example, one week, is provided through communication network, it is possible to adapt immediately to the up-to-date meals. Also, since the shopping list which can be used for purchasing at one time is provided, it is possible to make a purchasing without a waste. On the other hand, by delivering the food materials collectively to the user, it is further possible to save the time otherwise necessary. Also, if the food materials are left, the other menu is provided in accordance with the food material data of leftover food materials, so that it is possible to effectively consume the food materials without a further waste.

Further, according to the invention, since it is possible to change or modify the food menu at any time irrespective of before and after the purchasing of the food materials collectively at one time, the system according to the invention can provide extremely high freedom in which the food menu may be changed based on the leftover food materials after the purchasing of the food materials at one time, and may previously be changed before the purchasing of the food materials at one time.

### BRIEF DESCRIPTION OF THE DRAWINGS

The above and other objects, features and advantages of the present invention will be apparent from the following description of a preferred embodiment of the invention explained with reference to the accompanying drawings, in which:

FIG. 1 is a schematic block diagram showing a food menu providing system according to the invention; and

FIG. 2 is a flow chart for explaining the flow of the food menu providing system according to the invention.

### PREFERRED EMBODIMENT OF THE INVENTION

Now, an embodiment according to the invention is explained with reference to the drawings.

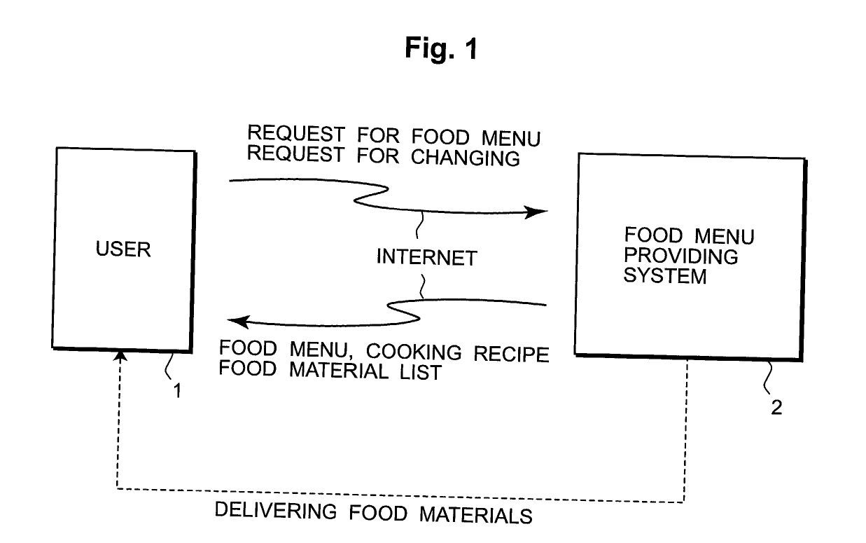

A schematic block diagram illustrating a food menu providing system according to the invention is shown in FIG. 1. As shown, the food menu providing system of the instant invention is one in which a user 1 of this system requests food menus to the food menu providing system 2 through a communication network such as a typical example of the Internet and, in accordance with this request, the food menu providing system provides the food menus, cooking recipes and food material lists applicable for a predetermined period, e.g., one week to the user 1 through the Internet. Specifically, the food menu providing system 2 is, for example, a food menu providing site operated on a server built on the communication network, and the user 1 accesses to the food menu providing site by using an HTML browser, etc. operated on a personal computer of the user. On the food menu providing site, the user can set predetermined conditions such as food materials to be removed for food allergy, the number of persons to be served, and a period for providing the food menu. Also, the food menus to be provided may be one in which special food menus for one having meal limitation because of diabetes or high blood pressure or for a diet, as well as general food menus for general family may be provided. On deciding the food menus, it is desired that the same menu be not provided frequently. Also it is desired that data of all the food materials used in the provided food menus applicable for a predetermined period be collectively included on the food material list transmitted to the user 1 so as to be used by the user 1 for purchasing at one time at the supermarket. Further, as shown with the dotted line in FIG. 1, it is also possible to deliver the food materials themselves.

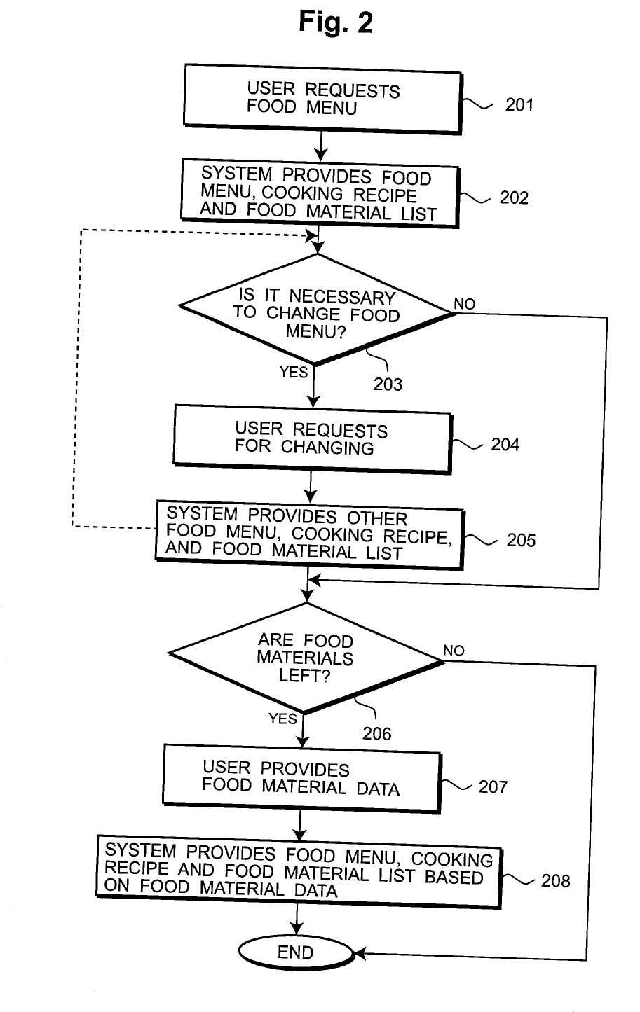

Next, the food menu providing system according to the invention is explained in more detail with reference to a flow chart of FIG. 2 for explaining the flow of the food menu providing system. First, the user 1 accesses to the food menu providing system 2, and requests the food menus applicable for a predetermined period (step 201). On requesting, it is possible to set the above-described various conditions.

When the food menu is requested, the food menu providing system 2 provides daily food menus applicable for the predetermined period, a cooking recipe for each food menu, and food material data including quantity, etc. of all food materials necessary to the food menus applicable for the predetermined period, to the user 1 through the communication network (step 202). Specifically, these data are displayed on the display screen of the personal computer of the user 1 in a form displayable by the HTML browser, etc. The user 1 can also download these data to the personal computer and use these data by offline. Further, each data may be transmitted by the e-mail, of course. Since the cooking recipe can be displayed together with still images or movie images, the cooking method, etc. can easily be understood. Here, it is possible to inform the user 1 of cooking hours, cooking methods, etc. by a voice or a sound. That is, kinds or quantity of seasoning, how to cook, how long, which plan, which food materials, etc. are guided by the voice, and after the passing of a predetermined grilled time, simmered time, etc., a stop sign is made. By doing so, it is not necessary to always watch the display screen by being guided through the voice in accordance with the real cooking time, so that even if other cooking or other housework is conducted in parallel, the meal is not burnt or boiled excessively.

Based on the provided food material list, the user 1 purchases the food materials at a supermarket, etc. When the predetermined period is a period of about one week, all the food materials can be purchased at one time. However, when the food menus are provided for a long period of about one month, it is desirable to provide food material lists with the listing being divided into several times. By purchasing the food materials to be used for the predetermined period at one time, the food materials can effectively be consumed and it is possible to prevent the food materials from wastefully being left over. When the user desires to take the food material list to the supermarket, the food material list may be printed out and taken to the supermarket. However, for example, when the food material list is provided from the food material providing system 2, the food material list is transmitted to a portable terminal unit, etc. supporting the e-mail of the user. By doing so, it is possible to easily confirm the shopping list at the supermarket without going to the trouble to print out.

Here, by receiving cooperation from a shop selling the food materials such as a supermarket, it is possible to save the time for purchasing. That is, simultaneously with the transmitting of the food material list to the user 1, the same food material list is transmitted to the shop in cooperation. Since a name, etc. of the each user 1 is included in the food material list transmitted to the shop, it is possible to identify each user. At the shop, food materials which are used by the food menus applicable for a predetermined period are collected in one lot in advance. Then, the user 1 goes to the shop, and the shopping is finished only by purchasing the prepared collected food materials. By doing so, since the user 1 oneself does not need to purchase the food materials written in the food material list by walking around in the shop, it is possible to greatly reduce the time for purchasing correctively. In this case, the advantage in which the waste stocks can be reduced is also gained at the shop. As explained above, it is possible for the food materials themselves to be delivered collectively to the user 1.

Next, there can be a case where the user 1 desires to change the provided food menu when, for example, the user wants to change a part of the food menus to the Chinese food because the Japanese foods have continued, or the food menu for a predetermined day is not necessary because the day is for eating out (step 203). When the change of the food menu is necessary, the user 1 requests to change the food menu to the food menu providing system 2 (step 204). Specifically, for example, when the food menu to be changed is designated by the user 1, the food menu providing system 2 decides other food menu from the food material data planned to be used by the food menu to be changed. In this case, it is desirable that the user 1 can designate various conditions, for example, styles such as Japanese food, Western food and Chinese food, or kinds such as meat and fish. Then, the food menu providing system 2 provides the food menu which is decided instead of the provided food menu, the cooking recipe of this food menu, and the food material list if there are any food materials to be additionally purchased (step 205). If there are many food menus to be changed, the change can be requested with respect to each of the many food menus, of course. Also, if the user 1 further desires to change the renewed food menu, it goes without saying that it is possible to request the change of the food menu again. Further, in the case where the number of persons to be served decreases, it is possible to provide the cooking recipe in which the quantities, etc. of the food materials are changed, without changing the provided food menu by making the change request to the food menu providing system again. The change may be requested after the purchasing of the food materials based on the food material list as well as before the purchasing of the food materials. The reason that the food menu can be changed after the purchasing of the food materials is that the food menu can be provided from the food material data as explained hereunder. Therefore, even if the food menu is changed, the food materials are not wasted.

Though the food materials are purchased at one time based on the food material list provided as above, and though the meal is made based on the cooking recipe in accordance with the provided food menu, the food materials are purchased with excess quantity because the food materials are sold in a “pack”, so that the food materials could not help being left. Also, though it was planned at the beginning that the dinner would be taken by all family for a week, in the case where, for example, the persons who eat the meal in a decreased number because of an unexpected business, or the family's unexpected eating out, the food materials may be left. In the case where the food materials are left (step 206), the user 1 provides to the food menu providing system 2 the food material data including the names and quantities of the leftover food materials (step 207). Of course, food material data of various food materials such as food materials which are not included in the food material list provided in advance, for example, a food materials received as a gift, favorite foods, or food materials sold as bargain sale, can be provided to the system 2. By doing so, it is possible to effectively consume the leftover food materials in the refrigerator in addition to the food materials purchased at one time by utilizing the present system.

The food menu providing system 2 further provides food menus and cooking recipes which use the food materials based on the provided food material data (step 208). Here, in the provided food material data, regarding the food material in which the quantity is inputted, it is desirable that the food menu which can be cooked by using the food material within the quantity with the inputted quantity taken into consideration is searched (retrieved). However, it is not limited to this inputted quantity, and when there are food materials which should additionally be purchased, the food material list including these additional food materials is provided. In the case where the food material data are provided to the food menu providing system, it is possible to use the technology of “COOKING RECIPE PROVIDING SYSTEM AND COMPUTER READABLE RECORDING MEDIUM WITH COOKING RECIPE PROVIDING PROGRAM” of the Japanese Patent Application No. 2000-242797 filed by the same inventor as the present application. Also, in the case where the food menu providing system according to the invention is continuously used, the food menus provided at the step 208 can be incorporated into food menus for the next predetermined period, for example, the next week.

For example, in the case where the user desires to eat meals using food materials which are not suitable for purchasing at one time, e.g., raw food materials such as fresh slices of raw fish, the food materials may be purchased on the day they are eaten. In this case, the change of the food menus may be requested.

As has been described in the foregoing, according to the food menu providing system of the instant invention, by providing food menus applicable for a predetermined period together with cooking recipes and a shopping list for purchasing at one time, it is possible to effectively consume the food materials. Also, the food menu can optionally be changed by the user side, and the food menus of new meals can promptly be provided. Since the food menus are not only provided, but can also optionally be changed by the user side, the users do not lose interest therein. Even if another meal with the provided food menus is cooked, it can be made out the food menu again so as not to leave the food materials purchased at one time, so that the food materials can effectively be consumed without becoming spoiled with the leftover food materials. Further, the food menu provided by the food menu providing system 2 is of the electrical data, so that it can easily be renewed at all times. Therefore, the food menu providing system can promptly deal with, for example, a popular meal or a meal which is introduced by a cooking program on the television.

Further, according to the food menu providing system of the instant invention, since the time for considering the food menu is almost nil, a burden of housework to, for example, a woman of a two-earner family increasing in recent years is greatly reduced, which burden is physical or mental burden, or burden of time. Also, because the shopping list is provided for purchasing at one time, and the materials to be purchased are decided in advance, the time for shopping can be considerably shortened. Therefore, it is possible to make good use of the saved time for realizing an enjoyable life.

While the invention has been described in its preferred embodiment, it is to be understood that the words which have been used are words of description rather than limitation and that changes within the purview of the appended claims may be made without departing from the true scope of the invention as defined by the claims.

What is claimed is:

1. A food menu providing system provided on a communication network, for providing with a user food menus applicable for a predetermined period, said system being characterized in that:
said food menu providing system provides to said user through said communication network the following:
food menus applicable for said predetermined period;
a cooking recipe for each of said food menus; and
a food material list having food material data such as quantities of all food materials necessary to said food menus for said predetermined period.

2. The food menu providing system according to claim 1, wherein said food material list comprises a shopping list for use by said user to purchase at one time the food materials necessary to said food menus for said predetermined period.

3. The food menu providing system according to claim 2, wherein said shopping list is transmitted to a portable terminal unit supporting the e-mail.

4. The food menu providing system according to claim 1, wherein said food material list is further provided to a shop which sells the food materials, the food materials necessary to said food menus for said predetermined period are collected in advance at said shop, and the collected food materials are provided to said user.

5. The food menu providing system according to claim 1, wherein said food materials listed on said food material list are further collectively delivered to said user.

6. The food menu providing system according to claim 1, wherein said system is characterized in that other food menus instead of the provided food menus are provided in accordance with a request of said user based on the food materials necessary to said food menus for said predetermined period.

7. The food menu providing system according to claim 1, wherein said system is characterized in that if a part of said food materials is left, food menus which use the leftover food materials are further provided based on data of said leftover food materials.

8. The food menu providing system according to claim 1, wherein said system provides food menus which satisfy the conditions designated by said user.

9. The food menu providing system according to claim 1, wherein said cooking recipe includes at least any one of still image data, movie image data and voice data.

10. The food menu providing system according to claim 1, wherein said predetermined period is one week.
